(19) United States
(12) Patent Application Publication
(10) Pub. No.: US 2023/0161555 A1
(43) Pub. Date: May 25, 2023

(54) SYSTEM AND METHOD PERFORMING FLOATING-POINT OPERATIONS

(71) Applicant: SAMSUNG ELECTRONICS CO., LTD., SUWON-SI (KR)

(72) Inventors: SOOBOK YEO, SUWON-SI (KR); SEONGHWA EOM, SUWON-SI (KR)

(21) Appl. No.: 17/992,130

(22) Filed: Nov. 22, 2022

(30) Foreign Application Priority Data
Nov. 24, 2021 (KR) 10-2021-0163767

(51) Int. Cl. G06F 7/483

(52) U.S. Cl. CPC G06F 7/4836

(57) ABSTRACT

A method performing floating-point operations may include; obtaining operands having a floating-point format, calculating a gain based on a range of exponents for the operands, generating intermediate values having a fixed-point format by applying the gain to the operands, generating a fixed-point result value having the fixed-point format by performing an operation on the intermediate values, and transforming the fixed-point result value into a floating-point output value having the floating-point format.

### CROSS-REFERENCE TO RELATED APPLICATION

This application claims priority under 35 U.S.C. § 119 to Korean Patent Application No. 10-2021-0163767 filed on Nov. 24, 2021 in the Korean Intellectual Property Office, the subject matter of which is hereby incorporated by reference in its entirety.

### BACKGROUND

The inventive concept relates generally to systems performing arithmetic operations and methods that may be used in performing floating-point operations.

For a given number of digital bits, a floating-point format may be used to represent a relatively greater range of numbers than a fixed-point format. However, arithmetic operations on numbers expressed in the floating-point format may be more complicated than arithmetic operations on numbers expressed in the fixed-point format. Along with the development of various computational hardware, the floating-point format has been widely used. However, the accuracy and efficiency of certain applications (e.g., computer vision, neural networks, virtual reality, augmented reality, etc.) requiring the performance (or execution) of multiple arithmetic operations on floating-point numbers may vary in accordance with the type of arithmetic operations being performed. Such variability is undesirable and improvement in the performance of floating-point arithmetic operations is required.

### SUMMARY

The inventive concept provides systems and methods enabling the performance of more accurate arithmetic operations on floating-point numbers.

According to an aspect of the inventive concept, a method performing floating-point operations includes; obtaining operands, wherein each of the operands is expressed in a floating-point format, calculating a gain based on a range of operand exponents for the operands, generating intermediate values by applying the gain to the operands, wherein each of the intermediate values is expressed in a fixed-point format, generating a fixed-point result value by performing an arithmetic operation on the intermediate values, wherein the fixed-point result value is expressed in the fixed-point format, and generating a floating-point output value from the fixed-point result value, wherein the floating-point output value is expressed in the floating-point format.

According to an aspect of the inventive concept, a system performing floating-point operations may include; a gain calculation circuit configured to obtain operands and calculate a gain based on a range of operand exponents, wherein each of the operands is expressed in a floating-point format, a normalization circuit configured to generate intermediate values by applying the gain to the operands, wherein each of the intermediate values is expressed in a fixed-point format, a fixed-point operation circuit configured to generate a fixed-point result value by performing an arithmetic operation on the intermediate values, wherein the fixed-point result value is expressed in the fixed-point format, and a post-processing circuit configured to transform the fixed-point result value into a floating-point output value, wherein the floating-point output value is expressed in the floating-point format.

According to an aspect of the inventive concept, a system performing floating-point operations may include; a processor, and a non-transitory storage medium storing instructions enabling the processor to perform a floating-point operation. The floating-point operation may include: obtaining operands, wherein each of the operands is expressed in a floating-point format, calculating a gain based on a range of operand exponents for the operands, generating intermediate values by applying the gain to the operands, wherein each of the intermediate values is expressed in a fixed-point format, generating a fixed-point result value by performing an arithmetic operation on the intermediate values, wherein the fixed-point result value is expressed in the fixed-point format, and transforming the fixed-point result value into a floating-point output value, wherein the floating-point output value is expressed in the floating-point format.

### BRIEF DESCRIPTION OF THE DRAWINGS

Advantages, benefits, and features, as well as the making and use of the inventive concept may be more clearly understood upon consideration of the following detailed description together with the accompanying drawings, in which:

FIG. 1 is a flowchart illustrating a method performing floating-point operations, according to embodiments of the inventive concept;

FIG. 2 is a conceptual diagram illustrating a floating-point format according to embodiments of the inventive concept;

FIG. 3 is a flowchart further illustrating in one embodiment the step of calculating gain in the method of FIG. 1;

FIG. 4 is a flowchart further illustrating in one embodiment the step of generating a result value having a fixed-point format in the method of FIG. 1;

FIG. 5 is a partial, exemplary listing of pseudo-code for a floating-point operation according to embodiments of the inventive concept;

FIG. 6 is a flowchart further illustrating in one embodiment the step of generating an output value having a floating-point format in the method of FIG. 1;

FIG. 7 is a conceptual diagram illustrating a result value according to embodiments of the inventive concept;

FIGS. 8A and 8B are related flowcharts illustrating a method performing floating-point operations according to embodiments of the inventive concept;

FIG. 9 is a flowchart further illustrating in one embodiment the step of generating operands in the method of FIG. 1;

FIG. 10 is a flowchart further illustrating in one embodiment the step of generating an operand in the method of FIG. 9;

FIG. 11 is a partial, exemplary listing of pseudo-code for a floating-point operation according to embodiments of the inventive concept;

FIGS. 12A and 12B are related flowcharts illustrating a method performing floating-point operations according to embodiments of the inventive concept;

FIG. 13 is a block diagram illustrating a system performing floating-point operations according to embodiments of the inventive concept;

FIG. 14 is a block diagram illustrating a system according to embodiments of the inventive concept; and

FIG. 15 is a general block diagram illustrating a computing system according to embodiments of the inventive concept.

### DETAILED DESCRIPTION

Throughout the written description and drawings, like reference numbers and labels are used to denote like of similar elements, components, features and/or method steps.

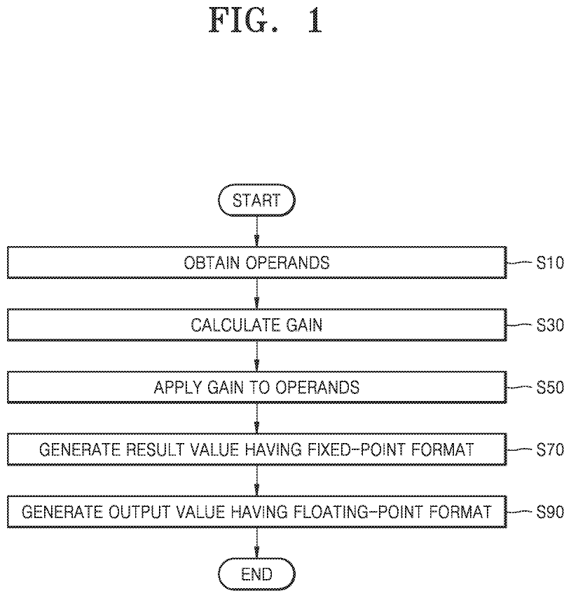

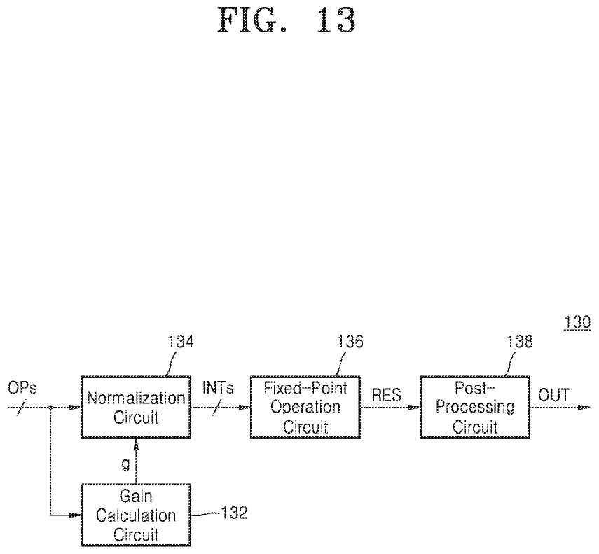

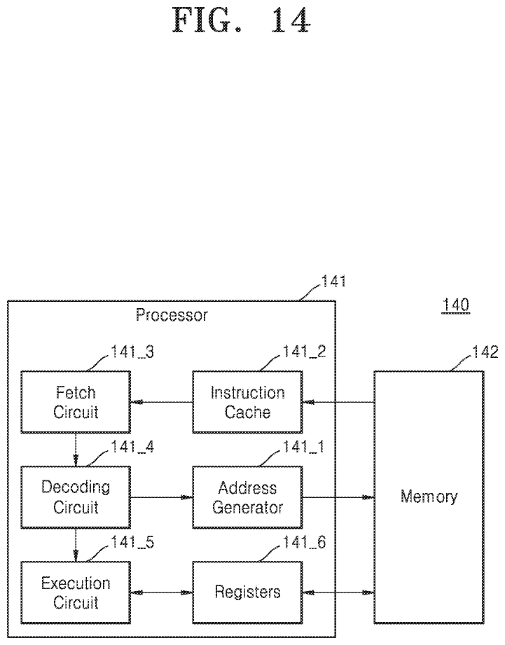

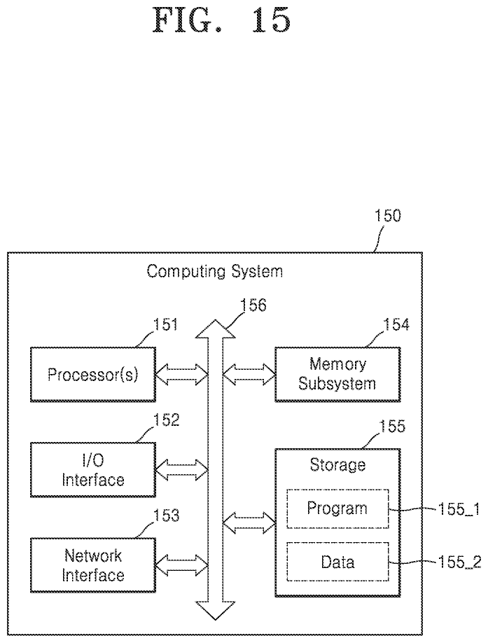

FIG. 1 is a flowchart illustrating a method performing floating-point operations according to embodiments of the inventive concept. Referring to FIG. 1, the illustrated and exemplary method may include steps S10, S30, S50, S70, and S90, wherein one or more of the steps may be performed using various hardware, firmware and/or software configurations, such as the one described hereafter in relation to FIG. 13. In some embodiments, one or more steps of a method consistent with embodiments of the inventive concept, such as those described hereafter in relation to FIGS. 14 and 15, may be performed by processor(s) configured to execute a sequence of instructions controlled by programming code stored in a memory.

Referring to FIG. 1, a number of operands may be obtained (e.g., generated) (S10), wherein each one of the operands may be expressed in a floating-point format. As noted above, when a number of digital bits processed in a digital system increases, the floating-point format may more accurately represent the numbers over an expanded (or wider) range.

In this regard, the floating-point format requires a reduced number of bits, as compared with an analogous fixed-point format. And this lesser number of bits requires less data storage space and/or a memory bandwidth within a defined accuracy.

The use of various floating-point formats is well understood in the art. For example, certain embodiments of the inventive concept may operate in accordance with a single-precision, floating-point format using 32 bits (e.g., FP32) and/or a half-precision floating-point format using 16 bits (e.g., FP16), such as those defined in accordance with the 754-2008 technical standard published by the Institute of Electrical and Electronics Engineers (IEEE). (See e.g., related background information published at www.ieee.org).

Using this assumed context as a teaching example, data storage space and/or memory bandwidth for a memory (e.g., a dynamic random access memory (or DRAM)) may be markedly reduced by storing FP16 data, instead of FP32 data. That is, a processor may read FP16 data from the memory and transform the FP16 data into corresponding FP32 data. Alternately, the processor may inversely transform FP32 data into corresponding FP16 data and write the FP16 data in the memory.

Further in this regard, a floating-point format having an appropriate number of bits may be employed in relation to an application. For example, in relation to the performance of a deep learning inference, a feature map and a corresponding weighting expressed in FP16 may be used. Accordingly, the deep learning may be performed with greater accuracy over a wider range, as compared with a fixed-point format (e.g., INT8). Further, the deep learning may be performed with greater efficiency (e.g., storage space, memory bandwidth, processing speed, etc.) as compared with the FP32 format. Accordingly, the use of a floating-point format having relatively fewer bits (e.g., FP16) may be desirable in applications characterized by limited resources (e.g., a portable computing system, such as a mobile phone).

Those skilled in the art will recognize from the foregoing that floating-point operation(s) may be particularly useful in various applications. For example, a floating-point operation may be used in relation to neural networks, such as in relation to a convolution layer, a fully connected (FC) layer, a softmax layer, an average pooling layer, etc. In addition, a floating-point operation may be used in relation to certain transforms, such as a discrete cosine transform (DCT), a fast Fourier transform (FFT), a discrete wavelet transform (DWT), etc. In addition, a floating-point operation may be used in relation to a finite impulse response (FIR) filter, an infinite impulse response (IIR) filter, a linear interpolation, a matrix arithmetic, etc.

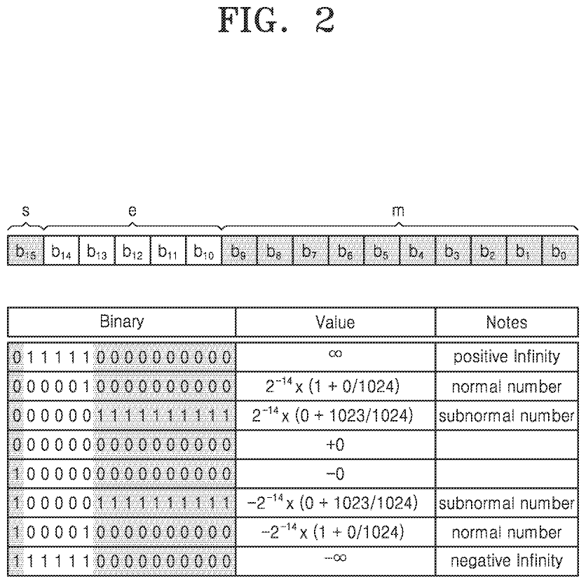

However, as the number of bits in a floating-point format decreases, the possibility of a material error occurring in arithmetic operation(s) due to rounding may increase. For example, as described hereafter in relation to FIG. 2, when four numbers {1024, 0.5, 1.0, 1.5} expressed in FP16 are summed, the sum may be one of {1026, 1027, 1028} according to particular addition orders. That is, during an addition operation performed on a set of numbers expressed in a floating-point format, an associative property may not be valid due to variations in rounding. Accordingly, a floating-point format having a relatively more bits (e.g., FP32) may have a long fraction part, and therefore, the influence of an error may be relatively weak. By way of comparison, a floating-point format having a relatively fewer bits (e.g., FP16) may have a short fraction part, and therefore, the influence of an error may be more significant. To remove error(s), various methods of transforming FP16 data into FP32 data and transforming an arithmetic operation result for FP32 data into FP16 data may be taken into account. However, such methods may not only cause an overhead for data transformation, but also decrease the efficiency of parallel data processing (e.g., single instruction multiple data (SIMD)), thereby decreasing the overall speed of performing arithmetic operation(s).

Hereinafter, in certain systems and methods performing floating-point operations consistent with embodiments of the inventive concept, an error due to repetitive rounding in the floating-point operations (e.g., error(s) occurring in relation to an addition order) may be removed. Additionally, in certain systems and methods performing floating-point operations consistent with embodiments of the inventive concept, the overall performance of applications including arithmetic operations performed on floating-point numbers may be improved by removing error(s) from the floating-point operations. More particularly, error(s) in floating-point arithmetic operations having relatively fewer bits may be removed, and floating-point numbers may be efficiently processed using hardware of relatively low complexity.

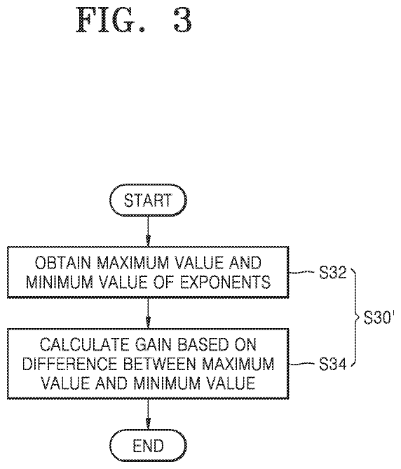

Referring to FIG. 1, after operands have been obtained (S10), a gain may be calculated (S30). For example, the gain may be calculated based on a range of exponents for the previously generated operands (hereafter, “operand exponents”). The gain may correspond to a value applied to (e.g., multiplied by) the operands in order to transform the operands having respectively different exponents into a common fixed-point format. For example, the gain ‘g’ may define a value ‘2^{g}’ applied to the respective operands. In some embodiments, the gain ‘g’ may be calculated (or determined) in advance, or dynamically calculated based on the generated operands. One example of a method step that may be used to calculate the gain ‘g’ (S30) will be described hereafter in relation to FIG. 3.

After being calculated (S30), the gain ‘g’ may be applied to the operands (S50). For example, each of the generated operands may be multiplied by the calculated gain (e.g., 2^{g}). Accordingly, a number of intermediate values, each expressed in a particular fixed-point format and respectively corresponding to one of the operands, may be generated. Here, the application of the calculated gain to the operands may be referred to as “normalization.”

Thereafter, a result value expressed in the fixed-point format (hereafter, a “fixed-point result value”) may be generated (S70). For example, one or more arithmetic operations may performed on the intermediate values in order to generate the fixed-point result value. In some embodiments, the step of generating the fixed-point result value may be performed by an arithmetic operation device designed to process numbers expressed in the fixed-point format, wherein the arithmetic operation may be iteratively performed in relation to the intermediate values (i.e., in relation to the generated operands).

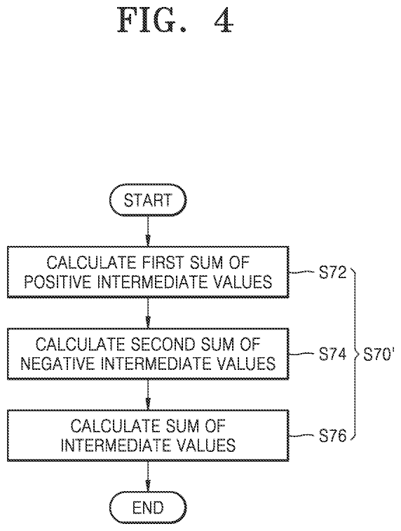

One example of the step of generating the fixed-point result value will be described hereafter in relation to FIG. 4.

Thereafter, an output value having a floating-point format (hereafter, “floating-point output value”) may be generated using the fixed-point result value (S90). For example, the previously generated, fixed-point result value (e.g., S70) may be transformed into a corresponding output value having the floating-point format. In some embodiments, the floating-point output value may be expressed similarly to the floating-point format of the generated operands.

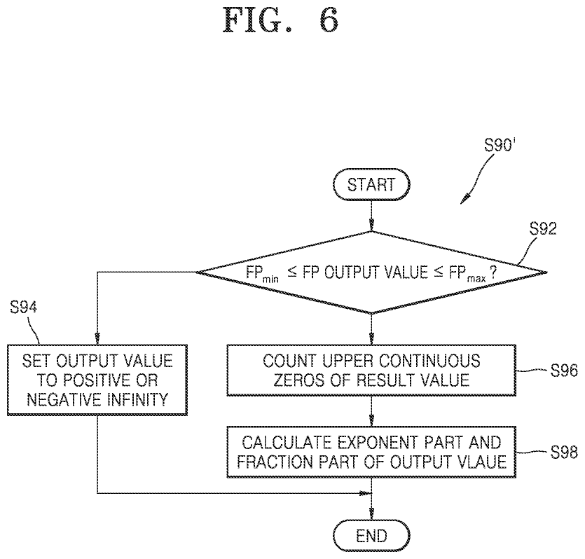

One example of the step of generating the floating-point output value will be described hereafter in relation to FIG. 6.

FIG. 2 is a conceptual diagram illustrating a floating-point format that may be used in relation to embodiments of the inventive concept. More particularly, an upper part of FIG. 2 shows a FP16 data structure, as defined by the IEEE 754-2008 technical standard, and a lower part of FIG. 2 shows examples of FP16 number(s).

Referring to the upper part of FIG. 2, an FP16 number may have a 16-bit length. A most significant bit (MSB) (b₁₅) may be a sign bit ‘s’ that denotes a sign for the FP16 number. Five bits (b₁₀ to b₁₄) following the MSB (b₁₅) may be an exponent part ‘e’, and 10 bits (b₀ to b₉) including a least significant bit (LSB) (b₀) may be a fraction part ‘m.’ According to FP16, a real number ‘v’ expressed in terms of (or represented by) the FP16 number may be defined in accordance with Equation 1 that follow:

$$v = {( - 1 )}^{{b}_{15}} \times {2}^{{( {b}_{14} {b}_{13} {b}_{12} {b}_{11} {b}_{10} )}_{2} - 15} \times \qquad [ Equation 1 ]$$

$${2}^{- 10} ( {2}^{10} ( 1 - q ) + {2}^{q} \cdot {( {b}_{9} {b}_{8} … {b}_{0} )}_{2} ) where$$

$$s = {b}_{15} , e = {( {b}_{14} {b}_{13} {b}_{12} {b}_{11} {b}_{10} )}_{2} , m = {( {b}_{9} {b}_{8} … {b}_{0} )}_{2} and \\ q = ( e == 0 ) = {( - 1 )}^{s} \times {2}^{e - 15} \times {2}^{q - 10} ( {2}^{10} ( 1 - q ) + m )$$

Here, ‘q’ may be 1 when the exponent part ‘e’ is zero, and ‘q’ may be 0 when the exponent part e is not zero; the real number ‘v’ may have a hidden lead bit assumed between the tenth bit (b₉) and the eleventh bit (b₁₀), such that when the exponent part ‘e’ is zero, the real number ‘v’ may be referred to as a “subnormal number,” wherein in the subnormal number, the hidden lead bit may be 0, and two times the fraction part ‘m’ may be used. Further, the real number ‘v’ that is not a subnormal number may be referred to as a “normal number,” and the hidden lead bit may be 1 in the normal number.

Referring to the lower part of FIG. 2, when the exponent part ‘e’ is 11111₂, the fraction part ‘m’ may be 0, and the FP16 number may be positive infinity or negative infinity according to the sign bit ‘s.’ Accordingly, a maximum value of the exponent part ‘e’ may be 11110₂ (i.e., 30), and a minimum value of the exponent part ‘e’ may be 00000₂ (i.e., 0). In addition, when both the exponent part ‘e’ and the fraction part ‘m’ are 0, the FP16 number may be positive zero or negative zero according to the sign bit ‘s.’ Hereinafter, FP16 will be further assumed and described as an example of a floating-point format that may be used in relation to embodiments of the inventive concept. However, other embodiments of the inventive concept may use different floating point formats.

FIG. 3 is a flowchart further illustrating in one embodiment the step of calculating the gain (S30′) in the method of FIG. 1.

Referring to FIGS. 1 and 3, the gain may be calculated by obtaining a maximum value and a minimum value of exponents associated with the generated operands (S32). As described above in relation to FIG. 1, the gain may be used to transform the generated operands having respectively different exponents into a common fixed-point format. As the gain increases, the number of bits in a fixed-point format may increase, and as the gain decreases, the number of bits in the fixed-point format may decrease. Accordingly, to calculate an optimal (or appropriate) gain, the maximum value and the minimum value for the exponents of the operands may be obtained. If the operands fall within a defined range, the maximum value and the minimum value of the exponents may be determined based on the range. Otherwise, if the operands do not fall within the range, or if the range of the operands cannot be accurately predicted, the maximum value and the minimum value of the exponents may correspond to a maximum exponent and a minimum exponent in a floating-point format, respectively. For example, if the range of the operands expressed in FP16 cannot be predicted, the maximum value of the exponents may be assumed to be 30, and the minimum value of the exponents may be assumed to be 0.

Thereafter, the gain may be calculated based on a difference between the maximum value and the minimum value (S34). In order to add a first operand having the maximum exponent and a second operand having the minimum exponent, respective corresponding values obtained by multiplying a different value between the exponent in the first operand and the exponent in the second operand by the first operand and the second operand may be added. In this manner, for example, the gain may be calculated in relation to the maximum value and the minimum value of the exponents obtained in method step S32.

In an arithmetic operation on N operands (wherein ‘N’ is an integer greater than 1), a real number ‘vₙ’ of an nth operand may be represented in accordance with Equation 2 below for 1≤n≤N.

$${v}_{n} = {( - 1 )}^{{s}_{n}} \times {\underbrace{{2}^{{e}_{n} - 15}}}_{exponent part} \times {2}^{- 10} \cdot {\underbrace{{2}^{{q}_{n}} ( {2}^{10} ( 1 - {q}_{n} ) + {m}_{n} )}}_{fraction part} \qquad [ Equation 2 ]$$

Consistent with Equation 1, in Equation 2, ‘sₙ’ denotes a sign bit of the nth operand, ‘eₙ’ denotes an exponent part of the nth operand, ‘mₙ’ denotes a fraction part of the nth operand, and ‘qₙ’ may be 1 when ‘eₙ’ is zero, and may be 0 when ‘eₙ’ is not zero.

To calculate a sum of the N operands, the N operands may be adjusted to have the same exponent. For example, the real number ‘vₙ’ of the nth operand may be adjusted in accordance with Equation 3 that follows:

$${v}_{n} = {( - 1 )}^{{s}_{n}} \times {\underbrace{{2}^{{e}_{max} - 15}}}_{unified exponent part} \times {2}^{- 10} \cdot {\underbrace{{2}^{{e}_{n} + {q}_{n} - {e}_{max}} ( {2}^{10} ( 1 - {q}_{n} ) + {m}_{n} )}}_{adjusted fraction part} \qquad [ Equation 3 ]$$

Here, ‘sₙ’ denotes the sign bit of the nth operand, and ‘eₘₐₓ’ denotes an exponent of an operand having a maximum exponent among the N operands.

Consistent with the method of FIG. 1, the step of applying the gain to the operands (S50) may include determining a real number ‘fₙ’ by applying the gain ‘g’ to the real number ‘vₙ’ of Equation 2 in accordance with Equation 4 that follows:

fₙ=2^{e}^{ₙ}^{+q}^{ₙ}^{-e}^{ₘₐₓ}^{+g}(2¹⁰(1−qₙ)+mₙ) [Equation 4]

Here, Equation 4 may correspond to a real number of an nth intermediate value corresponding to the nth operand in the description of the method of FIG. 1. To maximally preserve significant digits of an operand, the gain ‘g’ may satisfy Equation 5 that follows:

g≥eₘₐₓ−(eₘᵢₙ+qₘₐₓ) [Equation 5]

Here, ‘eₘᵢₙ’ denotes an exponent of an operand having a minimum exponent among the N operands, and ‘qₘₐₓ’ may be 0 or 1 in accordance with a minimum value emiₙ of the exponent of the operand. That is, if ‘eₘᵢₙ,’ is 0, ‘qₘₐₓ’ may be 1, otherwise, if ‘eₘᵢₙ’ is not zero, ‘qₘₐₓ’ may be 0. As gain increases, a resource for processing a fixed-point number may increase, and thus, gain may be set as a minimum value (e.g., “eₘₐₓ−(eₘᵢₙ+qₘₐₓ)”) satisfying Equation 5. For example, if the range of the N operands cannot be predicted, ‘eₘₐₓ’, ‘eₘᵢₙ’ and ‘qₘₐₓ’ may be respectively assumed to be 30, 0, and 1. Accordingly, gain ‘g’ may be 29. If the gain ‘g’ is 29, the real number ‘fₙ’ to which the gain g is applied may be represented by Equation 6 that follows:

fₙ=2^{e}^{ₙ}^{+q}^{ₙ}⁻¹(2¹⁰(1−qₙ)+mₙ) [Equation 6]

Thus, a maximum value of the real number ‘fₙ’ may be [2^{g}(2¹⁰+mₙ)=2²⁹(2¹⁰+mₙ)], and when the maximum value of the real number ‘fₙ’ is expressed in a fixed-point format, at least 40 bits may be required (40=g+11). In addition, a minimum value of the real number ‘fₙ’ may be ‘mₙ’, and at least 10 bits may be required. Accordingly, if a range of operands cannot be predicted in the context of FP16, hardware capable of performing a 40-bit fixed-point operation may be used.

In some embodiments, however, the gain ‘g’ may not satisfy Equation 5. For example, when the number of bits which a system uses for fixed-point operations is limited, gain may be set to a less value than [eₘₐₓ−(eₘᵢₙ+qₘₐₓ)]. Accordingly, gain may be determined based on the number of bits in a fixed-point format (e.g., the number of bits of an intermediate value and/or an output value).

FIG. 4 is a flowchart further illustrating in one embodiment the step of generating the fixed-point result value (S70′) in the method of FIG. 1. More particularly, the flowchart of FIG. 4 illustrates an addition operation as one possible example of an arithmetic operation that may be used to generate the fixed-point result value (S70) of FIG. 1 in relation to intermediate values.

Referring to FIGS. 1 and 4, a first sum of positive intermediate values may be calculated (S72), and a second sum of negative intermediate values may be calculated (S74). Extending the floating-point format example (FP16) of FIG. 2, floating-point number(s) may include a sign bit and intermediate values having a fixed-point format, and may be generated from operands expressed in FP16. Accordingly, intermediate values may be classified as either positive intermediate values or negative intermediate values in accordance with their respective sign bit value. Accordingly, a first sum of the positive intermediate values and a second sum of the negative intermediate values may be calculated. In some embodiments, two hardware components (e.g., adders) may be used to calculate the first sum and the second sum, respectively. In some embodiments, a single hardware component (e.g., an adder) may be used to sequentially calculate the first sum and the second sum.

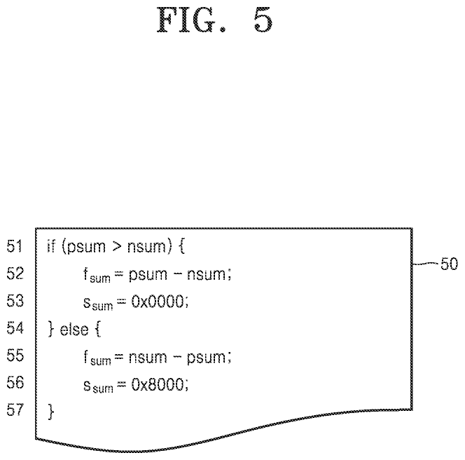

Once the first sum and second sum have been calculated (S74), a sum of intermediate values may be calculated (S76). For example, the sum of intermediate values may be calculated based on a difference between the first sum and the second sum. In some embodiments, an absolute value of the first sum may be compared with an absolute value of the second sum, and the sum of the intermediate values may be calculated in accordance with a comparison result. One example of method step S76 will be described hereafter in some additional detail with reference to FIG. 5.

FIG. 5 illustrates a partial listing of pseudo-code 50 that may be used to perform a floating-point operation according to embodiments of the inventive concept. In some embodiments, the pseudo-code 50 of FIG. 5 may be executed to perform method step S76 of FIG. 4. Referring to FIGS. 4 and 5, a sum of intermediate values may be calculated based on a first sum of positive intermediate values and a second sum of negative intermediate values. Thus, in the pseudo-code 50 of FIG. 5, the term ‘psum’ may denote an absolute value of the first sum (e.g., a value indicated by bits excluding a sign bit), and the term ‘nsum’ may denote an absolute value of the second sum (e.g., a value indicated by bits excluding a sign bit). In FIG. 5, the term ‘fₛᵤₘ’ may denote an absolute value of a result value, and the term ‘sₛᵤₘ’ may denote a sign of the result value. Here, in some embodiment, terms fₛᵤₘ and sₛᵤₘ may be expressed using 16 bits.

Referring to FIG. 5, psum may be compared with nsum (line 51). If psum is greater than nsum (psum>nsum) (i.e., if the absolute value of the first sum is greater than the absolute value of the second sum), then lines 52 and 53 are executed. Otherwise, if psum is less than or equal to nsum (psum≤nsum) (i.e., if the absolute value of the first sum is less than or equal to the absolute value of the second sum), then lines 55 and 56 are executed.

Accordingly, if psum is greater than nsum (psum>nsum), in line 52, an absolute value fₛᵤₘ of a result value may be calculated by subtracting nsum from psum. Additionally in line 53, a MSB of sₛᵤₘ indicating a sign of the result value may be set to 0 indicating a positive number.

If psum is less than or equal to nsum (psum≤nsum), in line 55, the absolute value fₛᵤₘ of the result value may be calculated by subtracting psum from nsum. Additionally in line 56, the MSB of sₛᵤₘ indicating a sign of the result value may be set to 1 indicating a negative number.

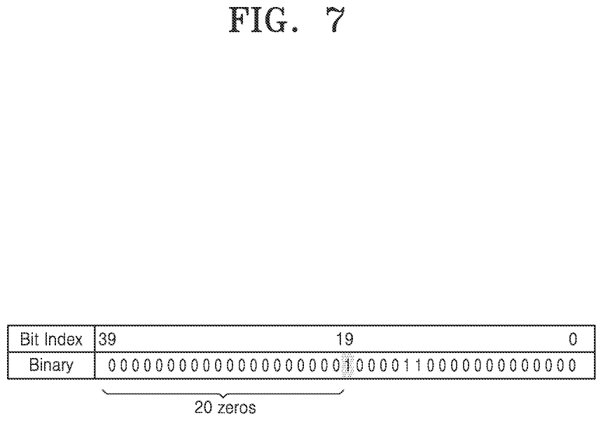

FIG. 6 is a flowchart further illustrating in one embodiment the step of generating the floating-point output value (S90) in the method of FIG. 1, and FIG. 7 is a conceptual diagram illustrating an exemplary floating-point output value.

Referring to FIGS. 1, 6 and 7, a floating-point (FP) output value may be compared with a minimum value FPₘᵢₙ and a maximum value FPₘₐₓ of the floating-point format. For example, it may be determined whether the fixed-point result value generated in method step S70 of the method of FIG. 1 falls within a range between a maximum value (i.e., 0111101111111111₂) of FP16 excluding positive infinity and a minimum value (i.e., 1111101111111111₂) of FP16 excluding negative infinity. As shown in FIG. 6, if the FP output value is greater than the maximum value FPₘₐₓ of the floating-point format or less than the minimum value FPₘᵢₙ of the floating-point format, the method may proceed to method step S94. Otherwise, if the FP output result is less than or equal to the maximum value FPₘₐₓ of the floating-point format and greater than or equal to the minimum value FPₘᵢₙ of the floating-point format, the method proceeds to method steps S96 and S98.

If the FP output value is greater than the maximum value FPₘₐₓ of the floating-point format or less than the minimum value FPₘᵢₙ of the floating-point format, the FP output value may be set to positive infinity or negative infinity (S94). For example, if the result value is greater than the maximum value (i.e., 0111101111111111₂) of FP16, the FP output value may be set to a value indicating positive infinity, i.e., 0111110000000000₂. Alternately, if the result value is less than the minimum value (i.e., 1111101111111111₂) of FP16, the FP output value may be set to a value indicating negative infinity, i.e., 1111110000000000₂.

If the FP output result is less than or equal to the maximum value FPₘₐₓ of the floating-point format and greater than or equal to the minimum value FPₘᵢₙ of the floating-point format, upper continuous zeros of the result value may be counted (S96). For example, as shown in FIG. 7, in a 40-bit FP output value, upper continuous zeros may be counted to determine a counted value (e.g., 20 zeros may be determined in the illustrated example of FIG. 7). In some embodiments, when the fixed-point result value may include a sign bit, however, upper continuous zeros excluding the sign bit may be counted. In some embodiments, the upper continuous zeros may be counted using a function (e.g., clz) implemented in a processor or a hardware accelerator. Accordingly, a number nlz of upper continuous zeros may be obtained in accordance with Equation 7 that follows:

nlz=clz(fₛᵤₘ) [Equation 7]

Referring to FIG. 6, an exponent part and a fraction part of a FP output value may be calculated (S98). For example, if an absolute value (or bits excluding a sign bit) of the result value has a 40-bit length as illustrated in FIG. 7, and the number of upper continuous zeros, counted in method step S96 is greater than 29 (e.g., the gain ‘g’), there may be leading 1 at a tenth bit (b9) or less. Accordingly, the FP output value may correspond to a subnormal number of FP16. When the output value corresponds to a subnormal number, an exponent part ‘eₛᵤₘ’ and a fraction part ‘mₛᵤₘ’ of the FP output value may be calculated in accordance with Equation 8 that follows:

eₛᵤₘ=0x0000, mₛᵤₘ=fₛᵤₘ [Equation 8]

Otherwise, if the absolute value (or bits excluding the sign bit) of the result value has a 40-bit length as illustrated in FIG. 7, and the number of upper continuous zeros counted in method step S96 is less than or equal to 29 (e.g., the gain ‘g’), the FP output value may correspond to a normal number, and bit shift may be determined as (g−nlz) and rounding may be performed so that leading 1 is located at an eleventh bit (e.g., b10). When the FP output value corresponds to a normal number, and the gain ‘g’ is 29, the exponent part eₛᵤₘ and the fraction part mₛᵤₘ of the FP output value may be calculated in accordance with Equation 9 that follows:

eₛᵤₘ=(29−nlz)<<10, mₛᵤₘ=round(fₛᵤₘ,(29−nlz)) [Equation 9]

Accordingly, an output value sumₒᵤₜ expressed in FP16 may be calculated in accordance with Equation 10 that follows, using sₛᵤₘ generated, for example, by the pseudo code 50 of FIG. 5, wherein eₛᵤₘ and mₛᵤₘ may be calculated in accordance with Equation 8 and/or Equation 9.

sumₒᵤₜ=(sₛᵤₘ+eₛᵤₘ+mₛᵤₘ) [Equation 10]

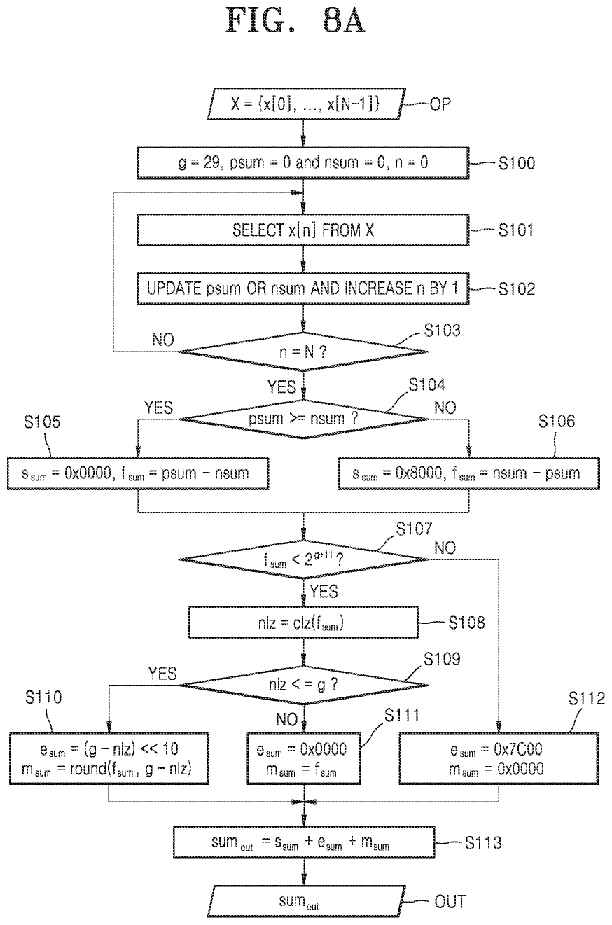

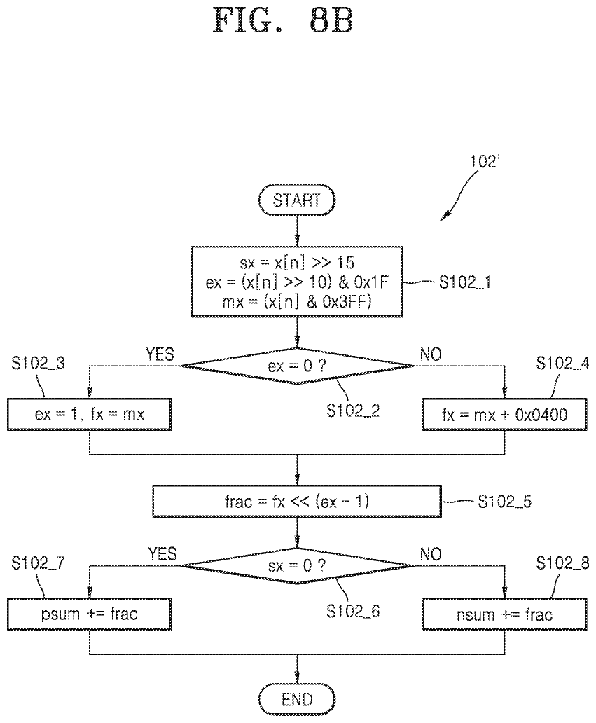

FIGS. 8A and 8B are related flowcharts illustrating a method for performing floating-point operations according to embodiments of the inventive concept. More particularly, the flowchart of FIG. 8A illustrates one implementation example for the method of FIG. 1 in relation to a FP16 operation, and the flowchart of FIG. 8B further illustrates in one example the method step S102 of the method of FIG. 8A.

Referring to FIG. 8A, it is assumed that before the method for performing floating-point operations is performed, operand data OP (or e.g., a set X including N operands X[0] to X[N−1]) has been obtained.

Variables may then be initialized (S100). For example, the gain ‘g’ may be set to 29, ‘psum’ corresponding to a first sum of positive intermediate values and ‘nsum’ corresponding to a second sum of negative intermediate values may be set to 0, and an index ‘n’ may also be set to 0.

An operand x[n] may be selected from set X (S101). That is, one of the operands OP may be obtained.

Then, ‘psum’ or ‘nsum’ may be updated, and n may be increased by 1 (S102). For example, if the selected operand x[n] is a positive number, ‘psum’ may be updated, and if the operand x[n] is a negative number, ‘nsum’ may be updated. One example of method step S102 is described hereafter in some additional details below with reference to FIG. 8B.

Then, ‘n’ may be compared with ‘N’ (S103). If ‘n’ differs from ‘N’ (e.g., if n is less than N), the method loops may proceed to steps S101 and S102, else if n is equal to N (e.g., if ‘psum’ and ‘nsum’ have been fully calculated, the method may proceed to method step S104.

That is, ‘psum’ may be compared with ‘nsum’ (S104). For example, if ‘psum’ is greater than or equal to ‘nsum’ (S104=YES), the method proceeds to method step S105 and a MSB of ‘sₛᵤₘ’ may be set to 0, and ‘fₛᵤₘ’ may be calculated by subtracting ‘nsum’ from ‘psum.’ Alternately, if psum is less than nsum (S104=NO), the method proceeds to method step S106 and the MSB of ‘sₛᵤₘ’ may be set to 1, and ‘fₛᵤₘ’ may be calculated by subtracting ‘psum’ from ‘nsum.’

Then, ‘fₛᵤₘ’ may be compared with 2^{g+11} (S107). Here, for example, ‘fₛᵤₘ’ may be compared with 2^{g+11} to determine whether ‘fₛᵤₘ’ is greater than a maximum value of FP16. And, if ‘fₛᵤₘ’ is greater than or equal to 2^{g+1′1} (S107=NO), then the method proceeds to S112 wherein ‘eₛᵤₘ’ may be set to 0x7C00, and ‘mₛᵤₘ’ may be set to 0, so as to indicate positive infinity (S112).

If ‘fₛᵤₘ’ is less than 2^{g+11} (S107=YES), upper continuous zeros of ‘fₛᵤₘ’ may be counted using a clz function, and nlz may indicate the number of upper continuous zeros of ‘fₛᵤₘ’ (S108).

Then, ‘nlz’ may be compared with the gain ‘g’ (S109). For example, ‘nlz’ may be compared with the gain ‘g’ to determine whether ‘fₛᵤₘ’ is a subnormal or normal number of FP16. Thus, if ‘nlz’ is less than or equal to the gain ‘g’ (i.e., if fₛᵤₘ is a normal number of FP16) (S109=YES), then ‘eₛᵤₘ’ may be calculated by shifting (g−nlz) to the right by 10 times, and ‘mₛᵤₘ’ may be rounded off by (g-nlz) bits (S110). Else, if ‘nlz’ is greater than the gain ‘g’, (i.e., if fₛᵤₘ is a subnormal number of FP16) (S109=NO), then ‘eₛᵤₘ’ may be set to 0, and ‘mₛᵤₘ’ may be set to ‘fₛᵤₘ’ (S111).

Then, ‘sumₒᵤₜ’ may be calculated (S113). For example, ‘sumₒᵤₜ’ may be calculated as a sum of ‘sₛᵤₘ’ calculated in method steps S105 or S106, and ‘eₛᵤₘ’ and ‘mₛᵤₘ’ may be calculated in method steps S110, S111, or S112. In this manner, output data OUT including sumₒᵤₜ may be generated.

As illustrated in FIG. 8B, the method step S102 (e.g., the step of updating ‘psum’ or ‘nsum’) may be variously implemented (e.g., as S102′). For example, a sign, an exponent, and a fraction may be extracted from an operand (S102_1). Here, a sign ‘sx’ may be set as an MSB of a 16-bit operand x[n], an exponent ‘ex’ may be set as five bits following the MSB in the operand x[n], and a fraction ‘mx’ may be set as 10 bits including an LSB in the operand x[n].

Accordingly, it may be determined whether the exponent ‘ex’ is 0 (S102_2) (e.g., it may be determined whether the operand x[n] is a subnormal number of FP16). That is, if the exponent ‘ex’ is 0 (S102_2=YES) (i.e., if the operand x[n] is a subnormal number), the method proceeds to operation S102_3; else, if the exponent ‘ex’ is non-zero (S102_2=N) (i.e., if the operand x[n] is a normal number), the method proceeds to operation S102_4.

If the operand x[n] is a subnormal number, the exponent ‘ex’ may be set to 1, and ‘fx’ may be set to ‘mx’ (S102_3); else, if the operand x[n] is a normal number, ‘fx’ may be set to a value generated by adding a hidden lead bit to ‘mx’ (S102_4). That is, ‘fx’ may correspond to a fraction of the operand, as adjusted in a manner consistent with FP16.

Then, ‘fx’ may be shifted (S102_5). For example, ‘fx’ may be left-shifted by (ex−1), and accordingly, ‘frac’ may have a fixed-point format.

Then, it may be determined whether ‘sx’ is 0 (S102_6). That is, if ‘sx’ is 0 (S102_6=YES) (i.e., if the operand x[n] is a positive number), ‘frac’ may be added to ‘psum’ (S102_7); else, if ‘sx’ is non-zero (S102_6=NO) (i.e., if the operand x[n] is a negative number), ‘frac’ may be added to ‘nsum’ (S102_8).

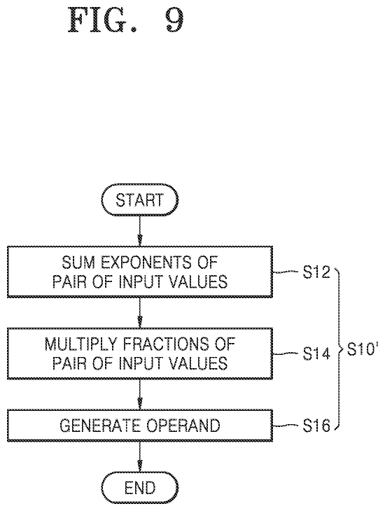

FIG. 9 is a flowchart further illustrating in one example step S10 of the method of FIG. 1. That is, operands may be obtained by performing the method steps S10′ illustrated in FIG. 9. In various applications, an arithmetic operation of summing products of pairs of input values, such as a scalar product or dot product of vectors, may be required. To this end, a product of a pair of input values may be generated as an operand in operation S10′ of FIG. 9, and operands may be generated by iteratively performing method step S10′ in conjunction with method step S30 in the method of FIG. 1.

Referring to FIGS. 1 and 9, exponents of a pair of input values may be summed (S12), and fractions of the pair of input values may be multiplied (S14). For example, a first input value ‘xₙ’ and a second input value ‘yₙ’ of FP16 may be expressed in accordance with Equation 11 that follows:

$${x}_{n} = {( - 1 )}^{{s}_{n} ( x )} \times {2}^{{e}_{n} ( x ) - 15} \times {2}^{- 10} \cdot {2}^{{q}_{n} ( x )} h ( {x}_{n} ) , \qquad [ Equation 11 ]$$

$$where h ( {x}_{n} ) = ( {2}^{10} ( 1 - {q}_{n} ( x ) ) + {m}_{n} ( x ) ) {y}_{n} = {( - 1 )}^{{s}_{n} ( y )} \times {2}^{{e}_{n} ( y )} \times {2}^{{e}_{n} ( y ) - 15} \times {2}^{- 10} \cdot {2}^{{q}_{n} ( y )} h ( {y}_{n} ) ,$$

$$where h ( {y}_{n} ) = ( {2}^{10} ( 1 - {q}_{n} ( y ) ) + {m}_{n} ( y ) )$$

A product ‘vₙ’ of the first input value xₙ and the second input value yₙ may be then be expressed in accordance with Equation 12 that follows:

$${v}_{n} = {x}_{n} \times {y}_{n} = {( - 1 )}^{{s}_{n}} \times {\underbrace{{2}^{{e}_{n} ( x ) - 15 + {e}_{n} ( y ) - 15}}}_{exponent part} \times {2}^{- 10} \cdot {\underbrace{{2}^{{q}_{n} ( x ) + {q}_{n} ( y ) - 10} h ( {x}_{n} ) \cdot h ( {y}_{n} )}}_{fraction part} \qquad [ Equation 12 ]$$

As represented in Equation 12, an exponent part of the product ‘vₙ’ may be based on an exponent eₙ(x) of the first input value xₙ and an exponent eₙ(y) of the second input value yₙ, and a fraction part of the product ‘vₙ’ may be based on a fraction 2^{q}^{ₙ}^{(x)}h(xₙ) of the first input value xₙ and a fraction 2^{q}^{ₙ}^{(y)}h(yₙ) of the second input value yₙ.

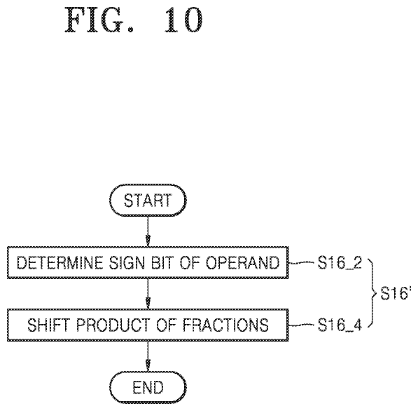

Then, an operand may be generated (S16). For example, the operand may be generated in relation to a sum of the exponents calculated in method step S12 and a product of the fractions calculated in the method step S14. One example of method step S16 will be described hereafter in relation to FIG. 10.

FIG. 10 is a flowchart further illustrating in one example the step of generating an operand (S16) in the method of FIG. 9.

Referring to FIGS. 9 and 10, a sign bit of an operand may be determined (S16_2). For example, a sign bit ‘sₙ’ of the product ‘vₙ’ of the first input value ‘xₙ’ and the second input value ‘yₙ’ may be determined in accordance with Equation 13 that follows, based on a sign bit sₙ(x) of the first input value ‘xₙ’ and a sign bit sₙ(y) of the second input value ‘yₙ.’

sₙ=xor(sₙ(x),sₙ(y)) [Equation 13]

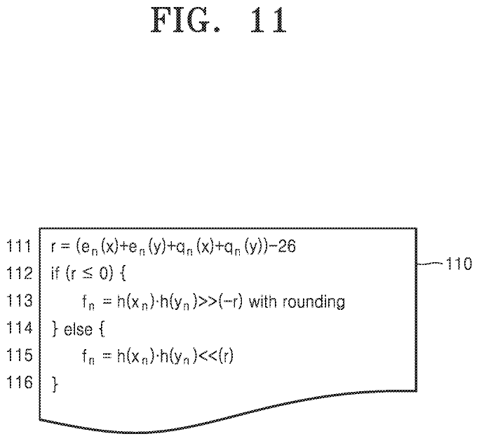

The, a product of fractions may be shifted (S16_4). Consistent with the foregoing, a product of the fractions of the first input value xₙ and the second input value yₙ may be calculated in step S14 of the method of FIG. 9, and the product of the fractions may be shifted based on the sum of the exponents calculated in step S12 of the method of FIG. 9. One example of the method step S16_4 will be described hereafter in relation to FIG. 11.

FIG. 11 is a partial listing of pseudo-code 110 that may be used to shift a product of fractions during a method of performing floating-point operations. That is, in some embodiments, the pseudo-code 110 of FIG. 11 may be executed to perform operation S16_4 of FIG. 10.

Referring to FIGS. 10 and 11, a shift amount may be determined (line 111). For example, in the product ‘vₙ’ of Equation 12, when the gain ‘g’ (g=29) is applied, the real number ‘fₙ’ may be expressed in terms of Equation 14 that follows:

fₙ=2^{e}^{ₙ}^{(x)+e}^{ₙ}^{(y)+q}^{ₙ}^{(x)+q}^{ₙ}^{(y)-26}h(xₙ)·h(yₙ) [Equation 14]

Accordingly, a shift amount ‘r’ may be defined according to line 111 of FIG. 11.

A shift direction may be determined according to a sign of the shift amount ‘r’ (line 112). As shown in FIG. 11, if the shift amount ‘r’ is a negative number, ‘fₙ’ may be calculated by shifting a product of h(xₙ) and h(yₙ) to the right by −r and rounding off the shifted value (line 113); else, if the shift amount ‘r’ is a positive number, ‘fₙ’ may be calculated by shifting the product of h(xₙ) and h(yₙ) to the left by r (line 115). The real number ‘fₙ’ generated by the pseudo code 110 may be provided as one of the operands in the method of FIG. 1.

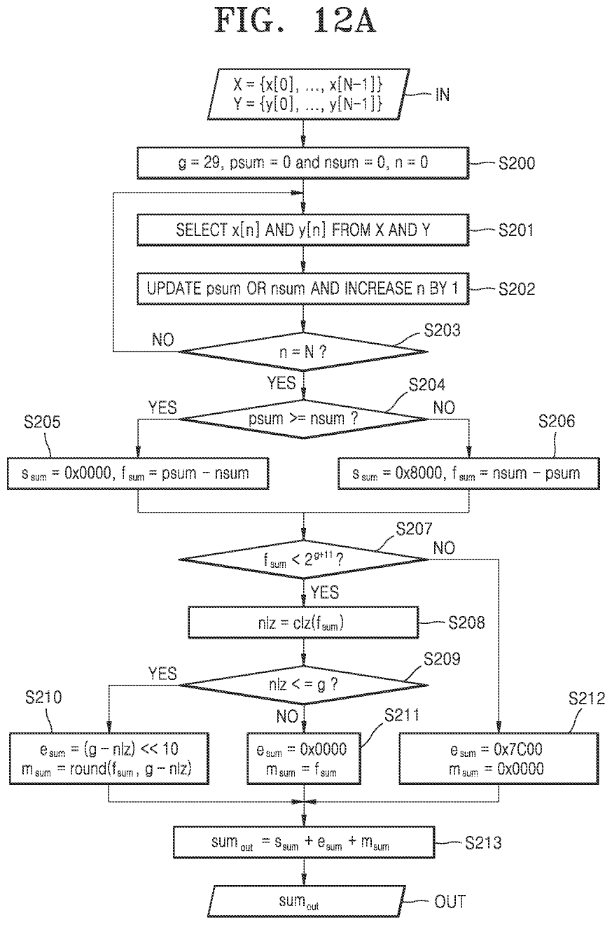

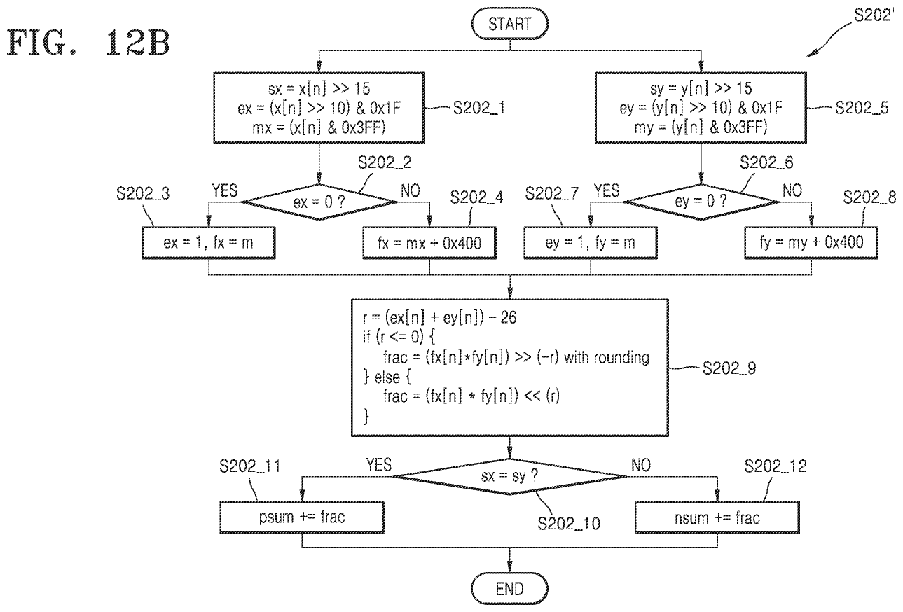

FIGS. 12A and 12B are related flowcharts illustrating a method for performing floating-point operations according to embodiments of the inventive concept. More particularly, the flowchart of FIG. 12A is an example of the method of FIG. 1, or method of summing products of pairs of numbers expressed in accordance with FP16, and FIG. 12B further illustrates in one example the step S202 of the method of FIG. 12A. Hereinafter, a description made with reference to FIGS. 8A and 8B may not be repeated in a description to be made with reference to FIGS. 12A and 12B.

Referring to FIGS. 8A, 8B and 12A, the method for performing floating-point operations assumes the prior provision of input data IN which may include a first set X including N first operands X[0] to X[N−1] and a second set Y including N second operands Y[0] to Y[N−1].

Accordingly, variables may be initialized (S200). For example, as shown in FIG. 12A, the gain ‘g’ may be set to 29, ‘psum’ corresponding to a first sum of positive intermediate values and ‘nsum’ corresponding to a second sum of negative intermediate values may be set to 0, and the index ‘n’ may also be set to 0. A pair of input values (e.g., a first input value x[n] and a second input value y[n]) may be selected from X and Y (S201). That is, a pair of input values may be selected.

Then, ‘psum’ or ‘nsum’ may be updated, and ‘n’ may be increased by 1 (S202). For example, if a product of the first input value x[n] and the second input value y[n] selected in step S201 is a positive number, ‘psum’ may be updated, and if the product of the first input value x[n] and the second input value y[n] is a negative number, ‘nsum’ may be updated. One example of method step S202 will be described hereafter in relation to FIG. 12B.

Then, ‘n’ may be compared with N (S203), and if n differs from N (S203=NO) (i.e., if n is less than N), the method may loop back to steps S201 and S202; else, if n is equal to N (i.e., if ‘psum’ and ‘nsum’ are fully calculated) (S203=YES), the method may proceed to method steps S204 through S213, wherein method steps S204 through S213 respectively correspond to method steps S104 to S113 of the method of FIG. 8A.

Referring to FIG. 12B, method step S202′ (e.g., updating ‘psum’ or ‘nsum’) may include extracting, the sign ‘sx’, the exponent ‘ex’, and the fraction ‘mx’ from the first input value x[n] (S202_1). Then, it may be determined whether the exponent ‘ex’ of the first input value x[n] is 0 (S202_2). If the exponent ex is 0 (S202=YES) (i.e., if the first input value x[n] is a subnormal number), then the exponent ‘ex’ may be set to 1 (S202_3), and ‘fx’ may be set to ‘m’. If the exponent ‘ex’ is non-zero (S202_2=NO) (i.e., if the first input value x[n] is a normal number), then ‘fx’ may be set by adding a hidden lead bit to ‘mx’ (S202_4).

Then, a sign ‘sy’, an exponent ‘ey’, and a fraction my may be extracted from the second input value y[n] (S202_5). Then, it may be determined whether the exponent ‘ey’ of the second input value y[n] is 0 (S202_6). Accordingly, if the exponent ‘ey’ is 0 (S202_6=YES) (i.e., if the second input value y[n] is a subnormal number), then the exponent ‘ey’ may be set to 1, and ‘fy’ may be set to ‘m’ (S202_7). However, if the exponent ‘ey’ is non-zero (S202_6=NO) (i.e., if the second input value y[n] is a normal number), then ‘fy’ may be set by adding a hidden lead bit to ‘my’ (S202_8).

Then, a shift may be performed (S202_9). For example, the shift amount ‘r’ may be calculated from an exponent ex[n] of the first input value x[n] and an exponent ey[n] of the second input value y[n]. If the shift amount ‘r’ is a negative number, right shift and rounding may be performed, and if the shift amount ‘r’ is a positive number, left shift may be performed.

The sign ‘sx’ of the first input value x[n] may be compared with the sign ‘sy’ of the second input value y[n] (S202_10). If both of these signs are the same (S202_10=YES), then ‘frac’ may be added to ‘psum’ (S202_11); else, if these signs are different, then ‘frac’ may be added to ‘nsum’ (S202_12).

FIG. 13 is a block diagram illustrating a system 130 that may be used to perform floating-point operations according to embodiments of the inventive concept. That is, in some embodiments, the system 130 may execute a method performing floating-point operations consistent with embodiments of the inventive concept.

Referring to FIGS. 1 and 13, the system 130 may include a gain calculation circuit 132, a normalization circuit 134, a fixed-point operation circuit 136, and a post-processing circuit 138. Here, each of the gain calculation circuit 132, the normalization circuit 134, the fixed-point operation circuit 136, and the post-processing circuit 138 may be variously configured in hardware, firmware and/or software. For example, each of the gain calculation circuit 132, the normalization circuit 134, the fixed-point operation circuit 136, and the post-processing circuit 138 may be implemented as one or more programmable component(s), such as a central processing unit (CPU), a digital signal processor (DSP), a graphics processing unit (GPU), and a neural processing unit (NPU). Alternately or additionally, each of the gain calculation circuit 132, the normalization circuit 134, the fixed-point operation circuit 136, and the post-processing circuit 138 may be implemented as a reconfigurable component, such as a field programmable gate array (FPGA), or a component such as an intellectual property (IP) core configured to perform one or more function(s).

The gain calculation circuit 132 maybe used to perform step S30 of the method of FIG. 1. For example, the gain calculation circuit 132 may receive operands (OPs) and calculate a gain ‘g’ based on a range of exponents for the operands OPs.

The normalization circuit 134 may be used to perform step S50 of the method of FIG. 1. For example, the normalization circuit 134 may receive the operands OPs and the gain ‘g’, and generate intermediate values (INTs) having a fixed-point format by applying the gain ‘g’ to the operands OPs.

The fixed-point operation circuit 136 may be used to perform step S70 of the method of FIG. 1. For example, the fixed-point operation circuit 136 may receive the fixed-point, intermediate values INTs and generate a fixed-point result value (RES) in accordance with a particular fixed-point format by performing one or more arithmetic operation(s) on the intermediate values INTs.

The post-processing circuit 138 may be used to perform step S90 in the method of FIG. 1. For example, the post-processing circuit 138 may receive the fixed-point result value RES and use the fixed-point result value RES to generate a floating-point output value (OUT) in accordance with a particular floating-point format.

FIG. 14 is a block diagram illustrating a system 140 according to embodiments of the inventive concept. As shown in FIG. 14, the system 140 may generally include a processor 141 and a memory 142, wherein the processor 141 is configured to perform one or more floating-point operations.

The system 140 may be variously implemented in hardware, firmware and/or software, such that the processor 141 execute instructions defined in accordance with programming code stored in the memory 142. In some embodiment, the system 140 may be an independent computing system, such as the one described hereafter in relation to FIG. 15. Alternately, the system 140 may be implemented as a part of more general (or more highly capable) system, such as a system-on-chip (SoC) in which the processor 141 and the memory 142 are commonly integrated within a single chip, a module including the processor 141 and the memory 142, and a board (e.g., a printed circuit board) including the processor 141 and the memory 142, etc.

The processor 141 may communicate with the memory 142, read instructions and/or data stored in the memory 142, and write data on the memory 142. As shown in FIG. 14, the processor 141 may include an address generator 141_1, an instruction cache 141_2, a fetch circuit 141_3, a decoding circuit 141_4, an execution circuit 141_5, and registers 141_6.

The address generator 141_1 may generate an address for reading an instruction and/or data and provide the generated address to the memory 142. For example, the address generator 141_1 may receive information which the decoding circuit 141_4 has extracted by decoding an instruction, and generate an address based on the received information.

The instruction cache 1412 may receive instructions from a region of the memory 142 corresponding to the address generated by the address generator 141_1 and temporarily store the received instructions. By executing the instructions stored in advance in the instruction cache 1412, a total time taken to execute the instructions may be reduced.

The fetch circuit 141_3 may fetch at least one of the instructions stored in the instruction cache 1412 and provide the fetched instruction to the decoding circuit 141_4. In some embodiments, the fetch circuit 141_3 may fetch an instruction for performing at least a portion of a floating-point operation and provide the fetched instruction to the decoding circuit 141_4.

The decoding circuit 141_4 may receive the fetched instruction from the fetch circuit 141_3 and decode the fetched instruction. As shown in FIG. 14, the decoding circuit 141_4 may provide, to the address generator 141_1 and the execution circuit 141_5, information extracted by decoding an instruction.

The execution circuit 141_5 may receive the decoded instruction from the decoding circuit 141_4 and access the registers 141_6. For example, the execution circuit 141_5 may access at least one of the registers 141_6 based on the decoded instruction received from the decoding circuit 141_4 and perform at least a portion of a floating-point operation.

The registers 141_6 may be accessed by the execution circuit 141_5. For example, the registers 141_6 may provide data to the execution circuit 141_5 in response to an access of the execution circuit 141_5 or store data provided from the execution circuit 141_5 in response to an access of the execution circuit 141_5. In addition, the registers 141_6 may store data read from the memory 142 or store data to be stored in the memory 142. For example, the registers 141_6 may receive data from a region of the memory 142 corresponding to the address generated by the address generator 141_1 and store the received data. In addition, the registers 141_6 may provide, to the memory 142, data to be written on a region of the memory 142 corresponding to the address generated by the address generator 141_1.

The memory 142 may have an arbitrary structure configured to store instructions and/or data. For example, the memory 142 may include a volatile memory such as static random access memory (SRAM) or DRAM, or a nonvolatile memory such as flash memory or resistive random access memory (RRAM).

FIG. 15 is a block diagram illustrating a computing system 150 capable of performing floating-point operations according to embodiments of the inventive concept.

In some embodiments, the computing system 150 may include a stationary computing system such as a desktop computer, a workstation, or a server or a portable computing system such as a laptop computer. The computing system 150 may include at least one processor 151, an input/output (I/O) interface 152, a network interface 153, a memory subsystem 154, a storage 155, and a bus 156, and the at least one processor 151 the I/O interface 152, the network interface 153, the memory subsystem 154, and the storage 155 may communicate with each other via the bus 156.

The at least one processor 151 may be named at least one processing unit and be programmable like a CPU, a GPU, an NPU, and a DSP. For example, the at least one processor 151 may access the memory subsystem 154 via the bus 156 and execute instructions stored in the memory subsystem 154. In some embodiments, the computing system 150 may further include an accelerator as dedicated hardware designed to perform a particular function at a high speed.

The I/O interface 152 may include input devices such as a keyboard and a pointing device and/or output devices such as a display device and a printer or provide access to the input devices and/or the output devices. A user may initiate execution of a program 155_1 and/or loading of data 155_2 and check an execution result of the program 155_1, through the I/O interface 152.

The network interface 153 may provide access to a network outside the computing system 150. For example, the network may include multiple computing systems and/or communication links, wherein each communication link may include one or more hardwired link(s), one or more optically-connected link(s), and/or one or more wireless link(s).

The memory subsystem 154 may store the program 155_1 or at least a portion of the program 155_1 to perform the floating-point operations described above with reference to the accompanying drawings, and the at least one processor 151 may perform at least some of operations included in a floating-point operation by executing the program (or instructions) stored in the memory subsystem 154. The memory subsystem 154 may include read-only memory (ROM), random access memory (RAM), and the like.

The storage 155 may include a non-transitory computer-readable storage medium and may not lose stored data even when power supplied to the computing system 150 is blocked. For example, the storage 155 may include a nonvolatile memory device and include a storage medium such as a magnetic tape, an optical disc, or a magnetic disk. In addition, the storage 155 may be detachable from the computing system 150. As shown in FIG. 15, the storage 155 may store the program 155_1 and the data 155_2.

Before being executed by the at least one processor 151, at least a portion of the program 155_1 may be loaded on the memory subsystem 154. The program 155_1 may include a series of instructions. In some embodiments, the storage 155 may store a file edited using a programming language, and the program 155_1 generated from the file by a compiler or the like or at least a portion of the program 155_1 may be loaded on the memory subsystem 154.

The data 155_2 may include data associated with a floating-point operation. For example, the data 155_2 may include operands, intermediate values, a result value, and/or an output value of the floating-point operation.

While the inventive concept has been particularly shown and described with reference to embodiments thereof, it will be understood that various changes in form and details may be made therein without departing from the spirit and scope of the following claims.

What is claimed is:

1. A method performing floating-point operations, the method comprising:
obtaining operands, wherein each of the operands is expressed in a floating-point format;
calculating a gain based on a range of operand exponents for the operands;
generating intermediate values by applying the gain to the operands, wherein each of the intermediate values is expressed in a fixed-point format;
generating a fixed-point result value by performing an arithmetic operation on the intermediate values, wherein the fixed-point result value is expressed in the fixed-point format; and
generating a floating-point output value from the fixed-point result value, wherein the floating-point output value is expressed in the floating-point format.

2. The method of claim 1, wherein the calculating of the gain includes:
obtaining a maximum value and a minimum value of the operand exponents; and
calculating the gain based on a difference between the maximum value and the minimum value of the operand exponents.

3. The method of claim 2, wherein the maximum value and the minimum value of the operand exponents are a maximum exponent and a minimum exponent of the floating-point format, respectively.

4. The method of claim 3, wherein the floating-point format is a half-precision floating-point format, and
the calculating of the gain based on the difference between the maximum value and the minimum value of the operand exponents includes subtracting 1 from a difference between a maximum exponent of the half-precision floating-point format and a minimum exponent of the half-precision floating-point format.

5. The method of claim 1, wherein the calculating of the gain based on the range of operand exponents includes calculating the gain based on a number of digits of the fixed-point format.

6. The method of claim 1, wherein the generating of the fixed-point result value by performing the arithmetic operation on the intermediate values includes:
calculating a first sum of positive intermediate values among the intermediate values;
calculating a second sum of negative intermediate values among the intermediate values; and
calculating a sum of the intermediate values based on a difference between the first sum and the second sum.

7. The method of claim 1, wherein the generating of the floating-point output value from the fixed-point result value includes:
counting a number of continuous zeros including a most significant bit and excluding a sign bit of the fixed-point result value to generate a counted value; and
calculating an exponent and a fraction of the floating-point output value based on the gain and the counted value.

8. The method of claim 1, wherein the generating of the floating-point output value from the fixed-point result value includes:
setting the floating point output value to a value expressed in the floating-point format; and
indicating one of positive infinity and negative infinity, if the fixed-point result value exceeds a range of the floating-point format.

9. The method of claim 1, wherein the obtaining of the operands includes, for each of the operands:
adding exponents of a pair of input values to generate a sum of exponents of the pair of input values; and
multiplying fractions of the pair of input values to generate a product of the fractions, wherein each of the pair of input values is expressed in the floating-point format.

10. The method of claim 9, wherein the obtaining of the operands further includes, for each of the operands:
determining a sign bit based on sign bits of the pair of input values; and
shifting the product of the fractions based on the sum of exponents of the pair of input values.

11. The method of claim 1, wherein the fixed-point format is a sign-magnitude format.

12. A system performing floating-point operations, the system comprising:
a gain calculation circuit configured to obtain operands and calculate a gain based on a range of operand exponents, wherein each of the operands is expressed in a floating-point format;
a normalization circuit configured to generate intermediate values by applying the gain to the operands, wherein each of the intermediate values is expressed in a fixed-point format;
a fixed-point operation circuit configured to generate a fixed-point result value by performing an arithmetic operation on the intermediate values, wherein the fixed-point result value is expressed in the fixed-point format; and
a post-processing circuit configured to transform the fixed-point result value into a floating-point output value, wherein the floating-point output value is expressed in the floating-point format.

13. The system of claim 12, wherein the gain calculation circuit is further configured to calculate a difference between a maximum value and a minimum value of the operands and calculate the gain based on the difference.

14. The system of claim 13, wherein the maximum value and the minimum value are a maximum exponent of the floating-point format and a minimum exponent of the floating-point format, respectively.

15. The system of claim 14, wherein the floating-point format is a half-precision floating-point format, and the gain calculation circuit is further configured to calculate the gain by subtracting 1 from a difference between the maximum exponent of the half-precision floating-point format and the minimum exponent of the half-precision floating-point format.

16. The system of claim 12, wherein the gain calculation circuit is further configured to calculate the gain based on a number of digits of the fixed-point format.

17. The system of claim 12, wherein the fixed-point operation circuit is further configured to calculate a first sum of positive intermediate values among the intermediate values, calculate a second sum of negative intermediate values among the intermediate values, determine a difference between the first sum and the second sum, and calculate a sum of the intermediate values based on the difference between the first sum and the second sum.

18. The system of claim 12, wherein the post-processing circuit is further configured to count a number of continuous zeros including a most significant bit of the fixed-point result value and excluding a sign bit of the fixed-point result value to generate a count value, and calculate an exponent and a fraction of the floating-point output value based on the gain and the count value.

19. The system of claim 12, further comprising:
a floating-point operation circuit configured to generate each of the operands by adding exponents of a pair of input values and multiplying fractions of the pair of input values, wherein each of the pair of input values is expressed in the floating-point format.

20. A system performing floating-point operations, the system comprising:
a processor; and
a non-transitory storage medium storing instructions enabling the processor to perform a floating-point operation,
wherein the floating-point operation comprises:
obtaining operands, wherein each of the operands is expressed in a floating-point format;
calculating a gain based on a range of operand exponents for the operands;
generating intermediate values by applying the gain to the operands, wherein each of the intermediate values is expressed in a fixed-point format;
generating a fixed-point result value by performing an arithmetic operation on the intermediate values, wherein the fixed-point result value is expressed in the fixed-point format; and
transforming the fixed-point result value into a floating-point output value, wherein the floating-point output value is expressed in the floating-point format.
